(19) United States
(12) Patent Application Publication
(10) Pub. No.: US 2024/0416758 A1
(43) Pub. Date: Dec. 19, 2024

(54) METHOD FOR AUTOMATICALLY TRANSFERRING A PIVOTABLE TROLLEY POLE

(71) Applicant: KIEPE ELECTRIC GMBH, Düsseldorf (DE)

(72) Inventor: Dietmar TISSEN, Düsseldorf (DE)

(21) Appl. No.: 18/702,583

(22) PCT Filed: Oct. 19, 2022
(86) PCT No.: PCT/EP2022/079041

§ 371 Date: Apr. 18, 2024

(30) Foreign Application Priority Data
Oct. 21, 2021 (DE) 10 2021 127 387.0

(51) Int. Cl. B60L 5/10; B60L 5/04

(52) U.S. Cl. CPC B60L 5/10; B60L 5/045; B60L 2200/18

(57) ABSTRACT

A method for automatically transferring at least one pivotable trolley pole, in particular of a trolleybus, from a start position into an end position which corresponds, in particular, to a contact position on an overhead line. The end position is assigned at least one setpoint position value, at least one actual position value of a current position of the trolley pole is detected, and the trolley pole is pivoted automatically about at least one axis. A setpoint speed is determined from a positional deviation of the detected actual position value from the setpoint position value, and a dynamic limitation to a dynamically limited setpoint speed is carried out in order to avoid overshooting when the end position is reached.

A separate sheet setting forth the replacement Abstract is provided herewith.

This application is a national stage filing of International (PCT) Application No. PCT/EP2022/079041, corresponding to International Publication No. WO 2023/066966 filed on Oct. 19, 2022, which in turn claims priority to German Application No. 10 2021 127 387.0 filed on Oct. 21, 2021. The entire contents of both of those applications are hereby incorporated by reference.

The present disclosure relates to a method for automatically transferring at least one pivotable trolley pole, in particular of a trolley bus, from a start position into an end position.

### BACKGROUND

The present disclosure relates to a method for automatically transferring at least one pivotable trolley pole, in particular of a trolley bus, from a start position into an end position which corresponds, in particular, to a contact position on an overhead line, wherein the end position is assigned at least one setpoint position value, at least one actual position value of a current position of the trolley pole is detected, and the trolley pole is pivoted automatically about at least one axis. A further aspect is a current collector system for arrangement on a vehicle roof, in particular of a trolley bus, with at least one pivotable trolley pole, which for transferring from a start position to an end position, to which at least one setpoint position value is assigned, is automatically pivotable about at least one axis, with a control unit for controlling the transfer and with at least one means for detecting at least one actual position value of the current position of the trolley pole.

Such current collector systems are used to connect an electrically powered vehicle to an overhead line for energy supply. In order to be able to connect the vehicle to the overhead line located above it, the current collector system is mounted as close as possible to the overhead line and therefore usually on the vehicle roof and equipped with at least one trolley pole. In order to contact the vehicle with the overhead line via the trolley pole, the trolley pole can be swiveled about a horizontal axis at its hinged end and thus in a vertical plane, so that the vertical distance between a free end of the trolley pole and the vehicle roof can be changed.

During this swiveling, the trolley pole is moved from a start position, such as a rest position in which the trolley pole rests on the vehicle roof, to an end position. If the vehicle is to be connected to the overhead line, which is also referred to as wiring, a contact position is used as the end position in which the free end of the trolley pole is in contact with the overhead line. Nevertheless, when the connection is disconnected, the start position can correspond to the contact position and the end position to the rest position of the trolley pole.

Particularly in the case of non-rail-bound vehicles, such as trolley buses, the vehicle may not be parallel under the overhead line during the transfer to the end position, but at an angle or offset to it. In some current collector systems, the trolley pole can therefore also be swiveled around a vertical axis and thus in a horizontal plane to compensate for this.

In most cases, the trolley pole is still contacted with the overhead line largely manually. The driver performs the positioning in the horizontal direction, i.e. swiveling around the vertical axis, manually. The driver visually estimates how far the trolley pole needs to be swiveled. After positioning in the horizontal direction, the driver releases a lock on the trolley pole so that its free end moves upwards in the vertical direction, driven by a spring. To compensate for minor errors during manual horizontal positioning, the overhead line is equipped with a catch funnel that catches the free end of the trolley pole and guides it to the overhead line. If the driver has not aligned the trolley pole in the horizontal plane with sufficient accuracy, it can still miss the overhead line and the catch funnel. In this case, the trolley pole would have to be brought back into the start position and repositioned again, which is a time-consuming process. When reaching the overhead line, the trolley pole is braked by the mechanically tensioned overhead line, whereby the overhead line yields until its tension equalizes the spring force acting on the trolley pole.

As this transfer is associated with a considerable mechanical load on both the overhead line and the trolley pole, automatic transfers are also increasingly being used. With these, the end position is assigned a setpoint position value that the trolley pole should assume in at least one plane after the transfer. A current collector system designed for automatic transfers also has at least one means for detecting at least one actual position value. This actual position value indicates the current position of the trolley pole in at least one plane. To control the transfer of the trolley pole, such current collector systems have a control unit that regulates the automatic swiveling of the trolley pole about at least one axis using the setpoint position value and the actual position value.

With this automatic swiveling, the trolley pole can be braked more strongly than by the tensioned overhead line alone. However, even with this method of automatic transfer, the trolley pole is only braked as soon as the actual position value has reached the setpoint position value, i.e. the trolley pole is in contact with the overhead line, for example. Due to the inertia, the trolley pole does not come to a stop immediately when the setpoint position value is reached. Instead, an overshoot occurs in which the actual position value changes beyond the setpoint position value. This overshoot is further intensified by the elastic properties of the trolley pole, which is articulated on one side and approximately 6 m long. This is because even if the hinged end of the trolley pole were to stop abruptly, the free end would overshoot like a whip.

This overshoot has a negative effect on the time required for the transfer. This is because the overshoot means that the actual position value does not correspond to the setpoint position value as soon as the trolley pole comes to a stop. The trolley pole must then be moved again in the opposite direction towards the setpoint position value. Here, too, overshooting can occur. A time-consuming settling process must therefore be carried out until the actual position value matches the setpoint position value for a stationary trolley pole and the transfer is complete. An overshoot in the vertical plane also leads to a mechanical load on the overhead line, which contributes to wearing off. Overshoot in the horizontal plane can lead to the overhead line being missed during wiring and the entire wiring process having to be carried out again.

A problem to be solved is therefore to enable a reliable and time-saving transfer of a swiveling trolley pole from a start position to an end position.

### SUMMARY

This problem can be solved in the case of a method of the type referred to above in that a setpoint speed is determined from a positional deviation of the detected actual position value from the setpoint position value, and a dynamic limitation to a dynamically limited setpoint speed is carried out in order to avoid overshooting when the end position is reached.

The setpoint speed can be easily determined from the positional deviation of the detected actual position value from the setpoint position value, in particular using a time specification. The dynamic limitation of the setpoint speed, i.e. its strength is dependent on the current position, in particular the actual position value, and changes with it, can prevent control with an excessively high setpoint speed, which would lead to overshooting. The elastic properties of the trolley pole can be easily considered by the dynamic limitation. The setpoint speed can be limited by the dynamic limitation and used as a dynamically limited setpoint speed to control the transfer of the trolley pole to the setpoint position value. The transfer of the trolley pole from the start position to the end position can be completed in the shortest possible time without overshooting.

The setpoint position value and/or the detected actual position value can be, for example, a height relative to the vehicle roof, an angle around the horizontal axis and/or an angle around the vertical axis.

For the transfer of several trolley poles each trolley pole can be transferred to its own end position. For example, in two-pole overhead line systems in which a vehicle is supplied with energy via two overhead lines, each trolley pole can be assigned its own contact position on one of the two overhead lines.

In an advantageous way, the dynamic limitation of the setpoint speed is dependent on the positional deviation of the actual position value from the setpoint position value. A dynamic limitation that depends not only on the actual position value, but also on the positional deviation, makes it easy to make the strength of the limitation of the setpoint speed dependent on the positional deviation still to be overcome at the end of the transfer. The strength of the dynamic limitation can be set in a fixed relation to the value of the positional deviation.

In this context, it can be particularly advantageous if, relative to the dynamic limitation for larger positional deviations, a stronger dynamic limitation occurs for smaller positional deviations. By applying a stronger dynamic limitation for smaller positional deviations, where the trolley pole only has to be moved a comparatively short distance to the end position, an excessively high setpoint speed leading to overshooting can be avoided towards the end of the transfer. As long as the positional deviations are comparatively large, the dynamic limitation can be weaker, so that the dynamically limited setpoint speed can assume higher values in order to enable a fast approach to the setpoint position value at the start of the transfer. The strength of the dynamic limitation can be inversely proportional to the positional deviation. As the actual position value approaches the setpoint position value, the dynamic limitation can specify an increasingly smaller value range of permissible dynamically limited setpoint speeds.

In a further development, the setpoint speed to be limited is determined from the positional deviation and a linear calculation factor. In this way, the setpoint speed to be limited can be derived from the positional deviation via a linear ratio. The linear calculation factor can be included as a factor of the linear term in the calculation of the setpoint speed from the positional deviation. In a particularly simple way, the setpoint speed to be limited can be determined as the product of the positional deviation and the linear calculation factor. The linear calculation factor can be in a reciprocal relationship to a predetermined transfer time or to a remaining fraction of a predetermined transfer time; in particular, the linear calculation factor can be the reciprocal of the transfer time or of the remaining fraction of the transfer time. The transfer time can be a predetermined time after which the transfer of the trolley pole from the start position to the end position should be completed, or a rough reference value for this time. The remaining fraction can be the time that has not yet elapsed of the predetermined transfer time that begins at the start of the transfer.

A maximum permissible speed can be specified for dynamic limitation as a function of the positional deviation, in particular as a lookup table with maximum permissible speeds assigned to individual positional deviations or positional deviation ranges. A threshold value for dynamic limitation can be specified in a simple manner using a maximum permissible speed, which is specified as a function of the positional deviation. This threshold, which is specified by the maximum permissible speed depending on the positional deviation, can limit the dynamically limited setpoint speed depending on the positional deviation. A lookup table makes it easy to specify maximum permissible speeds individually for specified positional deviations or to assign a common maximum permissible speed for several values of the positional deviation forming a positional deviation range and thus specify them for dynamic limitation. The maximum permissible speeds can, for example, be in the range of 0.4 degrees per second to 20 degrees per second. Higher maximum permissible speeds can be specified for larger positional deviations than for smaller positional deviations. The change in the maximum permissible speed can be greater for smaller positional deviations than for larger positional deviations, so that the maximum permissible speed is in a non-linear relationship to the positional deviation. For example, with a positional deviation of 20 degrees, the maximum permissible speed can be 7 degrees per second and fall rapidly for smaller positional deviations.

In this context, it can be particularly advantageous if the setpoint speed to be limited and the maximum permissible speed are compared with each other for dynamic limitation. By comparing the setpoint speed to be limited with the maximum permissible speed in this way, it can be easily determined for dynamic limitation whether the setpoint speed exceeds a limit value specified by the maximum permissible speed or not. Further dynamic limitation can be made dependent on the result of the comparison. In particular, the maximum permissible speed can be used as the limited setpoint speed if the setpoint speed to be limited exceeds the limit value specified by the maximum permissible speed. If the comparison shows that the setpoint speed to be limited is below the maximum permissible speed, the setpoint speed to be limited can be further processed for dynamic limitation or used as a dynamically limited setpoint speed for transfer.

Furthermore, the value of the maximum permissible speed can be used as the value of the dynamically limited setpoint speed if the amount of the setpoint speed to be limited is greater than the maximum permissible speed, or the value of the setpoint speed to be limited can be used as the value of the dynamically limited setpoint speed if the amount of the setpoint speed to be limited is less than the maximum permissible speed. In this way, the maximum permissible speed can be used to specify a direction-independent speed window for the setpoint speed, within which the setpoint speed is not too high and can therefore be used as a dynamically limited setpoint speed for further control. Only a setpoint speed outside this window can be cut off for dynamic limitation and thus replaced by the maximum permissible speed. Setpoint speeds beyond the maximum permissible speed, which would lead to overshooting, can be easily limited in this way. The size of this speed window used for dynamic limitation can be easily specified depending on the positional deviation using the maximum permissible speed.

In a further development, an actual speed is determined from the detected actual position value. By determining the actual speed from the detected actual position value, the current speed of the trolley pole can be considered in the control. The actual speed can be determined from the recorded actual position value in a simple manner by means of a time derivative, in particular a discrete time derivative. The result of the derivation can be low-pass filtered in order to filter out peaks that occur as artefacts, in particular due to the derivation of discrete measured values.

In an embodiment, a manipulated variable, in particular a pneumatic pressure, is determined from the dynamically limited setpoint speed and the actual speed, in particular for swiveling the trolley pole. By determining the manipulated variable used to swivel the trolley pole, which may be, for example, a pneumatic pressure, a hydraulic pressure, a motor speed or a stepping speed, from the dynamically limited setpoint speed and actual speed, the manipulated variable can be used to adapt the actual speed to the dynamically limited setpoint speed. The manipulated variable can be passed on to the actuators used to swivel the trolley pole so that the actual speed is increased or decreased via the manipulated variable in order to assume the value specified by the dynamically limited setpoint speed. An offset value can be added to the manipulated variable to compensate for the gravitational force, in particular to control the swiveling of the trolley pole about a horizontal axis, i.e. swiveling in a vertical plane.

Furthermore, the manipulated variable can be determined as the output variable of a proportional-integral control with the difference between the dynamically limited setpoint speed and the actual speed as the input variable. By using the difference between the dynamically limited setpoint speed and the actual speed as the input variable of the proportional-integral control, overshooting can be easily prevented, as would not be possible with conventional control based solely on the change in angle due to the inertia, the linkage at one end and the resulting large lever arm of the trolley pole, as such conventional control would overdrive. In an advantageous design, proportional-integral control can be realized by means of a PI controller. This PI controller can form a structural unit together with a limiting element that compares the setpoint speed to be limited and the maximum permissible speed and/or a subtraction element that determines the difference between the dynamically limited setpoint speed and the actual speed; in particular, the functions of the PI controller, the limiting element and/or the subtraction element can be realized by a common component.

The trolley pole can be swiveled automatically about a horizontal axis and a vertical axis. The swiveling about the horizontal axis and about the vertical axis can take place in parallel or in series. The end position can be assigned at least one setpoint position value for swiveling about the horizontal axis and at least one setpoint position value for swiveling about the vertical axis. Similarly, at least one actual position value of a current position of the trolley pole can be recorded for the horizontal axis and the vertical axis. In this way, the swiveling about the horizontal axis and about the vertical axis can be detected and/or controlled separately from each other. The process steps described for automatic transfer can be carried out separately for swiveling about the horizontal axis and swiveling about the vertical axis and, in particular, independently of each other. By swiveling about the horizontal axis and about the vertical axis, an angular offset in the horizontal plane between the vehicle alignment and the course of the overhead line can be compensated for, particularly in the case of non-rail-bound vehicles. The automatic swiveling about the horizontal axis and about the vertical axis also means that the entire transfer of the trolley pole to the end position can take place fully automatically, in particular without manual intervention.

In a further embodiment, the trolley pole is moved continuously from the start position to the end position. The continuous transfer of the trolley pole from the start position to the end position eliminates the need for intermediate stopping or pre-positioning during movement about at least one axis. A simpler and faster transfer process can be achieved. The continuous transfer can be carried out as a continuous movement around at least two axes simultaneously, in particular a horizontal axis and a vertical axis. Alternatively, a continuous transfer from the start position to the end position of a trolley pole that can be swiveled about two axes, in particular about a horizontal and a vertical axis, can be carried out as two continuous movements carried out in series. In a first continuous movement, the trolley pole can be swiveled continuously about the first axis to a first setpoint position value assigned to the end position and then swiveled continuously about the second axis to a second setpoint position value assigned to the end position.

It can also be advantageous if the at least one actual position value is recorded as an actual angle value. In the case of a swiveling trolley pole, an actual angular value can be easily recorded as an actual position value indicating the position. An angular velocity can be easily determined from the actual angular value. In the case of a trolley pole that can be swiveled in several axes, at least one actual position value can be recorded as an actual angular value for each axis. The setpoint position value assigned in the end position can be a setpoint angle value or a setpoint height value.

In this context, it can be advantageous if a detected actual angle value is converted into an actual height value to control the swiveling about a horizontal axis. Converting a recorded actual angle value into an actual height value can enable simple processing, particularly in the case of a setpoint position value that is available as a setpoint height value. An actual height value can also be output to the operating personnel, in particular a driver, and can be better recognized and understood by them for monitoring the transfer than an actual angle value. The recorded actual angle value can be converted into an actual height value considering the length of the trolley pole. The conversion into an actual height value can be carried out, in particular immediately, after the actual angle value has been recorded. For the further process steps for automatic transfer, in particular when determining the positional deviation, the detected actual angle value converted into an actual height value can be used in the manner described above.

The end position can be determined from sensor data and/or taken from a database. The end position can be determined as an angle about a horizontal axis, as an angle about a vertical axis and/or as a height difference with reference to a horizontal axis via sensors or taken from a database. The heights and the course of the overhead lines of an entire overhead line net can be stored in the database. The height difference in relation to the height of the vehicle roof can be determined from the height of the overhead line stored in the database and the height of the vehicle roof. The height difference and the length of the trolley pole can be used to easily determine a setpoint position value assigned to the position.

In a current collector system of the type referred to above, it is proposed for solving the problem that the control unit is set up to determine a setpoint speed from a positional deviation of a detected actual position value from the setpoint position value and to limit it dynamically to a dynamically limited setpoint speed in order to avoid overshooting when the position is reached.

The setpoint speed can be easily determined from the positional deviation of the detected actual position value from the setpoint position value, in particular using a time specification. By dynamically limiting the setpoint speed, i.e. limiting it in such a way that its strength depends on the current position, in particular the actual position value, and changes with it, the control unit can prevent the setpoint speed from being too high, which would lead to overshooting. The dynamic limitation allows elastic properties of the trolley pole to be considered. The setpoint speed can be limited by the dynamic limitation of the control unit as a dynamically limited setpoint speed for further control of the transfer of the trolley pole to the setpoint position value. The trolley pole can be transferred from the start position without overshooting in as short a time as possible.

The features described in connection with the method can also be used individually or in combination with the current collector system. This can result in the same advantages that have already been described.

According to one design embodiment, it is proposed that the current collector system for use in a two-pole overhead line system with two overhead lines has two trolley poles, which in particular can be swiveled independently of each other. Each of the trolley poles can be assigned its own control unit or a common control unit for controlling the transfer. Each of the trolley poles can be transferred at its own end position on one of the two overhead lines, whereby in particular three trolley poles that can be transferred from one another can be easily wired to one of the individually guided overhead lines.

In a further embodiment, the control unit is part of a modular control unit, in particular with digital and/or analogue inputs or outputs. A modular control unit can easily control the current collector system and/or the entire vehicle. The modular design of the control unit means that it can be easily adapted to different overhead line nets, changed operating conditions and/or different vehicle types. Digital and/or analogue inputs and outputs enable simple connection to sensors and/or detection means/mechanisms/systems, such as a means/mechanism/system for detecting an actual position value. The modular control unit can include a control computer in order to be able to implement individual control and regulation steps in a particularly simple way using software.

It may also be advantageous if the current collector system has pneumatic actuators for swiveling the trolley pole about a horizontal axis and/or a vertical axis. Pneumatic actuators can allow simple and cost-saving swiveling of the trolley pole about an axis. The pneumatic actuators can be connected to a pneumatic system of the vehicle. At least two pneumatic actuators can be assigned to each axis about which the trolley pole can be swiveled. These at least two pneumatic actuators can act in opposite directions on the trolley pole in order to allow it to swivel back and forth about the axis.

In a structurally advantageous embodiment, the current collector system has sensors for detecting the relative position of an overhead line, in particular relative to the vehicle roof. The sensors can be used to detect the relative position of an overhead line in relation to the current collector system and in particular in relation to the vehicle roof. The control unit and/or the modular control unit can be set up to process the sensor data and to be able to determine the end position and, in particular, at least one setpoint position value assigned to the end position from the detected relative position of the overhead line. The sensors can be used to detect the relative position of the overhead line as an angle and/or as a distance and can be passed on for processing.

In addition, the values required for positioning, in particular at least one setpoint position value assigned to the end position, can be stored as data in a control unit in relation to a defined vehicle position in the overhead line net. Depending on the vehicle position in the overhead line net, the appropriate data set can be used as a default for the trolley pole control. The current collector system can have a location determination device, in particular a GPS system, to determine the vehicle position in the overhead line net or can be connected to a location determination device, in particular one belonging to the vehicle.

### BRIEF DESCRIPTION OF THE DRAWINGS

Further details and advantages of a method according to the disclosure and of a current collector system according to the disclosure will be explained below by means of an exemplary embodiment shown schematically in the figures described below.

FIG. 1a shows a vehicle with a current collector system from the side;

FIG. 1b shows a vehicle with a current collector system from the top;

FIG. 2 shows the progression over time of the actual position value and the actual speed in a method for automatically transferring according to the state of the art,

FIG. 3 shows the progression over time of the actual position value and the actual speed in the method according to the disclosure; and

FIG. 4 shows the schematic structure of a control unit for carrying out the method according to the disclosure.

### DETAILED DESCRIPTION

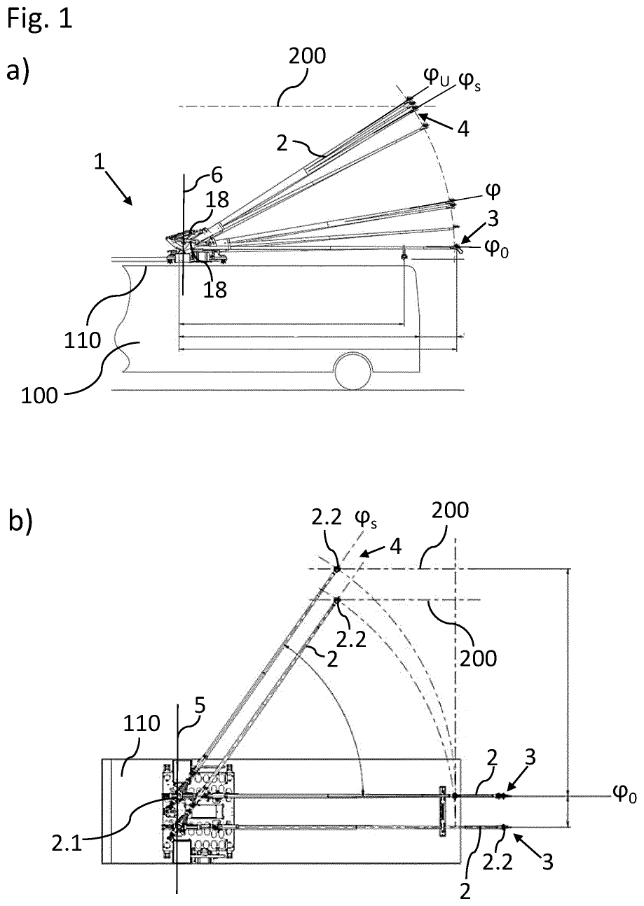

FIG. 1a and FIG. 1b show a trolley bus 100, which is connected to a line net consisting of two overhead lines 200 via a current collector system 1. The current collector system 1 is arranged on the vehicle roof 110. In order to connect the trolley bus 100 to the overhead lines 200, the current collector system has two trolley poles 2. As long as the trolley bus 100 does not need to be supplied with power via the overhead lines 200, the trolley poles 2 rest on the vehicle roof 110 in their respective rest position.

If a connection is now to be established with the overhead lines 200, the trolley poles 2 are each brought into a contact position in which they are in contact with one of the overhead lines 200. In the contact position, an electrical connection is established between the trolley bus 100 and the overhead lines 200 via the trolley poles 2, which is also referred to as “wiring”. During this wiring, each of the trolley poles 2 is thus transferred from its rest position, which represents a start position 3, to its contact position, which represents an end position 4. Each of the trolley poles 2 has a hinged end 2.1 about which the trolley pole 2 can be swiveled about a horizontal axis 5 and a vertical axis 6, so that a free end 2.2 of the respective trolley pole 2 can be moved in space relative to the trolley bus 100 in order to be brought into contact with one of the overhead lines 200. In order to enable this swiveling about the axes 5, 6, the current collector system 1 has several actuators 18, which enable swiveling about the respective axes 5, 6 and are designed as pneumatic cylinders in the exemplary embodiment shown.

During the transfer from the start position 3 to the end position 4, the trolley pole 2 is raised in a vertical plane when swiveling about the horizontal axis 5, as shown in FIG. 1a together with several intermediate steps. In this way, the free end 2.2 of the trolley pole 2 is raised to the height of the overhead line 200. When swiveling about the vertical axis 6, the trolley pole 2 is swiveled to the side in a horizontal plane, as shown in FIG. 1. Each of the two trolley poles 2 can be swiveled about its own vertical axis 6, which run parallel to each other and intersect the common horizontal axis 5 essentially at right angles. By swiveling in the horizontal plane, the position of the trolley pole 2 can be adapted to the route of the overhead line 200 if, for example, the trolley bus 100 is at an angle to the overhead line 200 or laterally offset to it, as shown in FIG. 1b.

For each axis 5, 6, both the end position 4 and the start position 3 are each assigned a setpoint position value φ_{S} or a start position value φ₀, which in the exemplary embodiment is the angle that the trolley pole 2 assumes when swiveling around the respective axis 5, 6 in the end position 4 or the start position 3. In order to enable automatic transfer of the trolley pole 2 to the end position 4, the current collector system 1 can detect the current position of the trolley pole 2. For this purpose, the current collector system 1 has at least one means or mechanism/system for detecting an actual position value φ for each of the axes 5, 6, which in the exemplary embodiment is the angle around the respective axis 5, 6 at which the trolley pole 2 is currently positioned. The actual position value φ, the start position value φ₀ and the setpoint position value φ_{S} can be detected relative to the rest position of the trolley pole 2, so that the start position value φ₀ can assume the value zero for the exemplary embodiment of FIG. 1, as the transfer shown takes place from the rest position as the start position 3.

In contrast to the method according to the disclosure for automatically transferring the trolley pole 2, the methods known from the prior art cause the trolley pole 2 to overshoot beyond the setpoint position value φ_{S} assigned to the end position 4, as shown in FIG. 1a. Due to the inertia of the trolley pole 2, it continues to move after reaching the setpoint position value φ_{S} and only comes to a standstill at an overshoot position φ_{U}. In order to complete the transfer to the end position 4, the trolley pole 2 must therefore be guided from the overshoot position φ_{U} back to the setpoint position value φ_{S}, which makes the known transfer methods time-consuming. Such an overshoot of the trolley pole 2 also causes an unwanted mechanical load on the overhead line 200 due to the force exerted on it by the trolley pole and also harbors the risk of the overhead line 200 being missed in the horizontal plane, for example due to an overshoot.

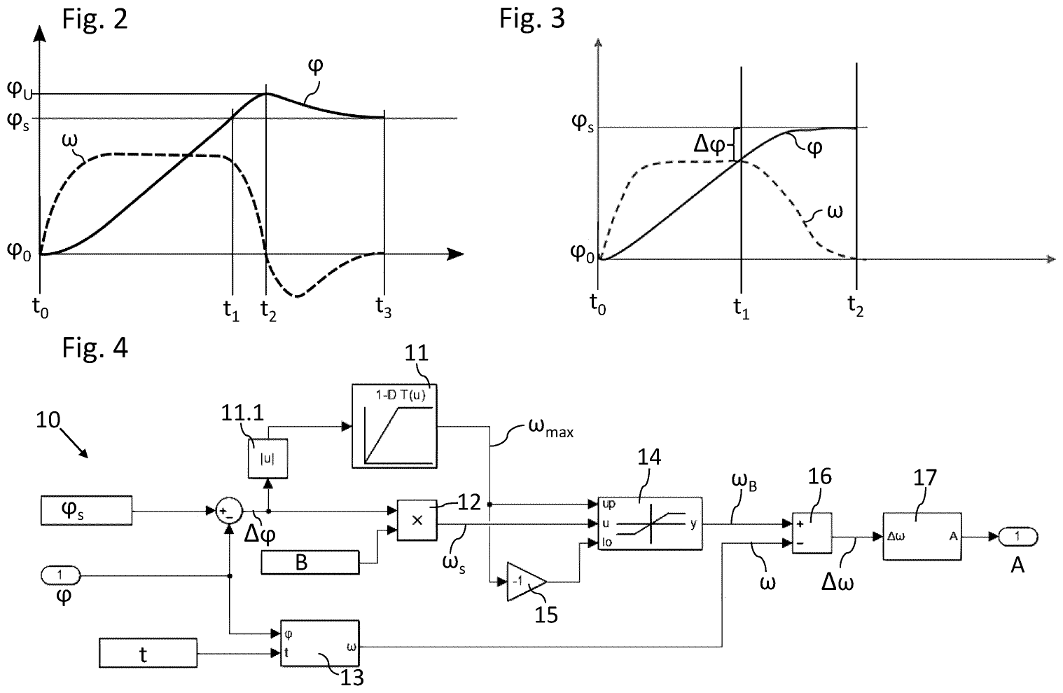

FIG. 2 shows the progression over time of the actual position value φ and the actual speed ω of the trolley pole 2 during a known automatic transfer. The transfer of the trolley pole 2 from the start position 3 to the end position 4 begins at the time t₀, at which the actual position value φ corresponds to the start position value φ₀. Starting from the start position value φ₀, the trolley pole 2 is accelerated so that its actual speed ω increases. Due to the inertia of the trolley pole 2, the increase in the actual speed ω is not sudden, but takes place over a certain period of time until the actual speed ω assumes a largely constant value. With this actual speed ω, the actual position value φ approaches the setpoint position value φ_{S} assigned to the end position 4 until the time t₁, at which the actual position value φ corresponds to the setpoint position value φ_{S}. From this point in time t₁, the actual speed ω is reduced, but cannot be abruptly set to zero due to the inertia of the trolley pole 2, so that the trolley pole 2 and thus also its actual position value φ continues to change beyond the setpoint position value φ_{S}.

Only at time t₂ the actual speed ω reaches the value zero, so that the trolley pole 2 comes to a stop. At time t₂, however, the trolley pole 2 assumes the overshoot position φ_{U}, which deviates from the setpoint position value φ_{S}. In order to complete the transfer to the end position 4, i.e. to bring the actual position value φ into alignment with the setpoint position value φ_{S} for a stationary trolley pole 2, the actual position value φ must be returned from the overshoot position φ_{U} to the setpoint position value φ_{S}. To do this, the trolley pole 2 is moved in the opposite direction, whereby the actual speed ω assumes a negative value. At the time t₃, the actual position value φ then corresponds to the setpoint position value φ_{S}, while the actual speed ω is zero at the same time. Only under these conditions the automatic transfer is completed without human intervention.

The progression over time of the actual position value Y and the actual speed ω is shown in simplified form in FIG. 2. In practical implementation, further overshoots above the setpoint position value φ_{S} can occur between time t₂ and time t₃, so that the transition can only be completed after a longer settling process.

In contrast to FIG. 2, FIG. 3 shows the progression over time of the actual position value φ and the actual speed ω during a transfer of the trolley pole 2 from the start position 3 to the end position 4 in accordance with the method according to the disclosure. Here too, the actual position value φ begins at the start time t₀ of the transfer at the start position value φ₀ and is changed by the increasing actual speed ω in the direction of the setpoint position value φ_{S}. Due to the dynamic limitation that is dependent on the positional deviation Δφ, which is described in more detail below, a control unit 10 of the current collector system 1 that controls the transfer reduces the actual speed ω at a point in time t₁ at which the actual position value φ does not yet match the setpoint position value φ_{S}. In the method according to the disclosure, the trolley pole 2 is already braked when the positional deviation Δφ of the detected actual position value φ from the setpoint position value φ_{S} is still not equal to zero.

Due to the inertia of the trolley pole 2, the actual speed ω can only be reduced continuously from the time t₁, but not abruptly. Accordingly, the actual position value Y continues to move in the direction of the setpoint position value φ_{S} even after the time t₁. The actual speed ω only assumes the value zero at the time t₂, so that the trolley pole 2 comes to rest. The dynamic limitation according to the disclosure is designed in such a way that the actual position value φ at time t₂ corresponds to the setpoint position value φ_{S} and the transfer is therefore completed without overshooting and, in particular, without a transient process. The trolley pole 2, which is articulated on one side, is gently braked as it approaches the setpoint position value φ_{S} in such a way that no whiplike overshoot of the free end 2.2 occurs. The end position 2 is therefore approached in a time-saving and more reliable manner.

As can be seen in FIG. 3, the actual position value φ is continuously transferred from the start position value φ₀ to the setpoint position value φ_{S}. This continuous transfer can take place both for the actual position value φ of a swiveling movement around axis 5 and for the actual position value φ of a swiveling movement around axis 6. As the actual position values φ of the swivels around the horizontal axis 5 and around the vertical axis 6 represent coordinates of a spherical coordinate system that are independent of each other, these individual continuous transfers to the setpoint position values φ_{S} can be carried out in parallel or in series.

FIG. 4 shows the schematic structure of the control unit 10, which is used to carry out the method for automatically transferring according to the disclosure. The setpoint position value φ_{S} and the actual position value φ serve as input variables for this control system. The setpoint position value φ_{S} can, for example, be taken from a database in which the height of the overhead line 200 or an angle to be assumed for contacting by the trolley pole 2 is stored in a spatially resolved manner, depending on the position of the trolley bus 100, or can be determined from sensor data of a sensor of the current collector system 1 used to detect the relative position of the overhead line 200.

The actual position value φ is detected by the at least one means/mechanism/system of the current collector system 1 provided for detecting it. If the actual position value φ is detected as an actual angle value by the means/mechanism/system for detecting it, but the setpoint position value φ_{S} is available as a length dimension, such as a height above the vehicle roof 110, a conversion not shown in the figure can be carried out beforehand. During this conversion, the recorded actual angle value is converted into an actual height value and this is used as the actual position value φ in the further process. Alternatively, the setpoint position value φ_{S} can also be converted into an angle measurement. Using the known length of the swiveling trolley pole 2, such a conversion from a spherical coordinate system to a Cartesian coordinate system or from a Cartesian coordinate system to a spherical coordinate system is possible in a simple manner.

The positional deviation Δφ is determined by subtraction from the actual position value φ and the setpoint position value φ_{S}. The positional deviation Δφ is passed on to a multiplier 12 as an input variable. Together with a predeterminable calculation factor B, this determines a setpoint speed ω_{S}. The calculation factor B can be determined from a remaining fraction of a transfer time specified for carrying out the entire transfer from the start position to the end position; in particular, it can be the value of this fraction. The multiplier 12 then multiplies this calculation factor B by the positional deviation Δφ and outputs the setpoint speed ω_{S}, which is thus in a linear relationship to the positional deviation Δφ with the calculation factor B as a linear factor. This setpoint speed ω_{S} corresponds to the speed at which the actual position value φ would have to be constantly moved in the direction of the setpoint position value φ_{S} in order to be brought into line with it within the transfer time. If the transfer time has already elapsed, the multiplier 12 can output a stored maximum achievable speed for the movement of the trolley pole 2 by the actuators as the setpoint speed ω_{S}.

When determining this setpoint speed ω_{S}, the avoidance of overshoot is not initially considered, so that overshoot could occur as described in connection with FIG. 2 if this setpoint speed ω_{S} were simply used for transfer.

To counteract overshooting, the positional deviation Δφ is also used for dynamic limitation via a maximum permissible speed ωₘₐₓ. In an absolute value element 11.1, the absolute value of the positional deviation Δφ is first determined so that the rest of the procedure can be carried out regardless of whether the position setpoint value φ_{S} assigned to the end position 4 is greater or less than the actual position value φ of the current position of the trolley pole 2.

The absolute value element 11.1 can be part of the downstream control component that determines the maximum permissible speed ωₘₐₓ, which in the example shown is designed as lookup table 11. Different maximum permissible speeds are stored in the lookup table 11, which are assigned to individual positional deviations. The positional deviation Δφ determined from the actual position value φ and the setpoint position value φ_{S} is compared with these stored positional deviations. Depending on the comparison result, the maximum permissible speed ωₘₐₓ is selected from the stored maximum permissible speeds or determined by interpolation between the stored maximum permissible speeds whose stored positional deviations come closest to the positional deviation Δφ. The values of the maximum permissible speed stored in the lookup table 11 can also decrease with decreasing values of the positional deviations assigned to them. In this way, the lookup table 11 determines increasingly smaller maximum permissible speeds ωₘₐₓ the closer the actual position value φ approaches the setpoint position value φ_{S}, i.e. the smaller the positional deviation Δφ becomes.

As an alternative to the lookup table 11, in which individual value pairs of positional deviations and maximum speeds or positional deviation ranges and their associated maximum speeds are stored, a calculation element can be used in which a function is used to calculate the maximum permissible speed ωₘₐₓ as a function of the positional deviation Δφ. This function can be designed in such a way that the maximum permissible speed ωₘₐₓ also decreases with decreasing positional deviations Δφ, in particular in a non-linear ratio.

The increasingly smaller values of the maximum permissible speed ωₘₐₓ with decreasing positional deviations Δφ enable a dynamic limitation in which a stronger limitation occurs for smaller positional deviations Δφ than for larger positional deviations Δφ.

The determined maximum permissible speed ωₘₐₓ is forwarded to a limiting element 14 together with the setpoint speed ω_{S}. As the sign of the setpoint speed ω_{S} depends on whether the actual position value φ is to be transferred from a start position value Po above or below the setpoint position value φ_{S} to the setpoint position value φ_{S}, the maximum permissible speed ωₘₐₓ is also fed to the limiting element 14 as an input variable via an inverter 15. As the maximum permissible speed ωₘₐₓ, as well as the value of the maximum permissible speed ωₘₐₓ inverted by the inverter 15, is thus fed to the limiting element 14, which therefore in fact specifies a minimum value of a permissible speed in the negative range, a speed window of permissible speeds is specified for the limiting element 14.

For dynamic limitation, the limiting element 14 now compares the setpoint speed ω_{S} to be limited and the maximum permissible speed ωₘₐₓ with each other. If the setpoint speed ω_{S} is outside the speed window specified by the maximum permissible speed ωₘₐₓ, the maximum permissible total speed ωₘₐₓ is output as the dynamically limited setpoint speed ω_{B} by the limiting element 14. However, if the setpoint speed ω_{S} is within the speed window, the value of the setpoint speed ω_{S} is output by the limiting element 14 as the value of the dynamically limited setpoint speed ω_{B} and used in the following. Due to this dynamic limitation, which depends on the positional deviation Δφ of the actual position value φ from the setpoint position value φ_{S}, comparatively large dynamically limited setpoint speeds are still permitted at the start of the transfer in the event of large positional deviations Δφ, while a stronger dynamic limitation and thus increasingly smaller dynamically limited setpoint speeds ω_{B} are permitted as the positional deviation Δφ decreases towards the end of the transfer in order to avoid overshooting beyond the setpoint position value φ_{S}.

Parallel to determining the dynamically limited setpoint speed ω_{B}, the actual speed ω is determined from the actual position value φ and a time signal t by a derivation element 13. The time signal t can correspond to a cycle time that the control unit requires to run through a control cycle. Both the actual speed ω and the dynamically limited setpoint speed ω_{B} are passed on as input signals to a subtraction element 16, which determines a speed difference Δω.

The speed difference Δω is forwarded to a PI controller 17, which uses it to determine a manipulated variable A used to swivel the trolley pole 2. The subtraction element 16 and the PI controller 17 form a proportional-integral control system with the dynamically limited setpoint speed ω_{B} and the actual speed ω as input variables and the manipulated variable A as output variable.

In particular, in a current collector system 1 with pneumatic actuators 18, the manipulated variable can be the pneumatic pressure used to swivel the trolley pole 2 around one of the axes 5, 6. The manipulated variable A causes a change in the position of the trolley pole and thus a change in the actual position value φ_{S}. After the manipulated variable A is output, the actual position value φ is therefore recorded again, so that the control steps described above are run through cyclically until the actual position value φ corresponds to the setpoint position value φ_{S} when the trolley pole 2 is at rest.

The method described above for automatically transferring a swiveling trolley pole 2 from a start position 3 to an end position 4 and the current collector system 1 enable a reliable and time-saving transfer of the trolley pole 2.

### LIST OF REFERENCE SYMBOLS

1 Current collector system
2 Trolley pole
2.1 End
2.2 End
3 Start position
4 End position
5 Axis
6 Axis
10 Control unit
11 Lookup table
11.1 Absolute value element
12 Multiplier
13 Derivation element
14 Limiting element
15 Inverter
16 Subtraction element
17 PI controller
18 Actuator
100 Trolleybus
110 Vehicle roof
200 Overhead line
φ₀ Start position value
φ Actual position value
φ_{S} Setpoint position value
φ_{U} Overshoot position
Δφ Positional deviation
ω Actual speed
ω_{S} Setpoint speed
ω_{B} Dynamically limited setpoint speed
ωₘₐₓ Maximum permissible speed
Δω Speed difference
A Manipulated variable
B Calculation factor
t Time

Having described the invention in detail and by reference to the various embodiments, it should be understood that modifications and variations thereof are possible without departing from the scope of the claims of the present application.

What is claimed is:

1. A method for automatically transferring at least one pivotable trolley pole from a start position into an end position, wherein at least one setpoint position value is assigned to the end position, at least one actual position value of a current position of the trolley pole is detected and the trolley pole is pivoted automatically about at least one axis, wherein a setpoint speed is determined from a positional deviation of the detected actual position value from the setpoint position value and is dynamically limited to a dynamically limited setpoint speed to prevent overshooting when the end position is reached.

2. The method according to claim 1, wherein the dynamic limitation of the setpoint speed is dependent on the positional deviation of the actual position value from the setpoint position value.

3. The method according to claim 2, wherein a stronger dynamic limit is set for smaller positional deviations relative to the dynamic limit for larger positional deviations.

4. The method according to claim 1, wherein the setpoint speed to be limited is determined from the positional deviation and a linear calculation factor.

5. The method according to claim 1, wherein for dynamic limitation, a maximum permissible speed is specified as a function of the positional deviation.

6. The method according to claim 5, wherein for dynamic limitation, the setpoint speed to be limited and the maximum permissible speed are compared with each other.

7. The method according to claim 5, wherein the value of the maximum permissible speed, if the setpoint speed to be limited is greater than the maximum permissible speed, or the value of the setpoint speed to be limited, if the setpoint speed to be limited is less than the maximum permissible speed, is used as the value of the dynamically limited setpoint speed.

8. The method according to claim 1, wherein an actual speed is determined from the recorded actual position value.

9. The method according to claim 1, wherein a manipulated variable for swiveling the trolley pole is determined from the dynamically limited setpoint speed and the actual speed.

10. The method according to claim 9, wherein the manipulated variable is determined as the output variable of a proportional-integral control with the difference between the dynamically limited setpoint speed and the actual speed as the input variable.

11. The method according to claim 1, wherein the trolley pole is automatically swiveled about a horizontal axis and a vertical axis.

12. The method according to claim 1, wherein the trolley pole is continuously moved from the start position to the end position.

13. The method according to claim 1, wherein the at least one actual position value is recorded as an actual angle value.

14. The method according to claim 13, wherein a detected actual angle value is converted into an actual height value to control the swiveling about a horizontal axis.

15. The method according to claim 1, wherein the end position is at least one of: determined from sensor data, or taken from a database.

16. A current collector system for arrangement on a vehicle roof with at least one pivotable trolley pole, which for transfer from a start position to an end position, to which at least one setpoint position value is assigned, is automatically pivotable about at least one axis, with a control unit for controlling the transfer and with at least one means for detecting at least one actual position value of the current position of the trolley pole, wherein the control unit is set up to determine a setpoint speed from a positional deviation of a detected actual position value from the setpoint position value and to limit it dynamically to a dynamically limited setpoint speed in order to avoid overshooting when the end position is reached.

17. The current collector system according to claim 16, wherein the control unit is part of a modular control device.

18. The current collector system according to claim 16, further including pneumatic actuators for swiveling the trolley pole about at least one of a horizontal axis or a vertical axis.

19. The current collector system according to claim 16, further including sensors for detecting the relative position of an overhead line.

20. The method according to claim 1, wherein the trolley pole is a trolley pole of a trolley bus, and wherein the end position corresponds to a contact position on an overhead line.
